(19) United States
(12) Patent Application Publication
(10) Pub. No.: US 2005/0170256 A1
(43) Pub. Date: Aug. 4, 2005

(54) Electrical power source apparatuses, electrical power source operational methods, and electrochemical device charging methods

(76) Inventor: John Cummings, Taipei (TW)

Correspondence Address: WELLS ST. JOHN P.S., 601 W. FIRST AVENUE, SUITE 1300, SPOKANE, WA, 99201, US

(21) Appl. No.: 10/769,670

(22) Filed: Jan. 30, 2004

(51) Int. Cl. H01M 6/18

(52) U.S. Cl. 429/322

(57) ABSTRACT

Electrical power source apparatuses, electrical power source operational methods, and electrochemical device charging methods are described. According to one aspect, an electrical power source apparatus includes a charge switching device configured in an enabled mode of operation to apply electrical energy from a power node to a plurality of electrochemical devices to charge the electrochemical devices, wherein the charge switching device is further configured in a disabled mode of operation to electrically isolate the electrochemical devices from the power node, a plurality of shunting paths individually configured to shunt electrical energy around a respective one of the electrochemical devices, and wherein the shunting paths are provided in a disengaged operational mode corresponding to the enabled mode of operation of the charge switching device and in an engaged operational mode corresponding to the disabled mode of operation of the charge switching device.

### TECHNICAL FIELD

This invention relates to electrical power source apparatuses, electrical power source operational methods, and electrochemical device charging methods.

### BACKGROUND OF THE INVENTION

The sophistication and uses of electrical devices have increased dramatically in recent years. Consumer items having electrical components are ubiquitous in communications, computing, entertainment, etc. The size of mobile telephones, notebook computers, music players, and other devices has continued to decrease while the capabilities and quality of the devices continues to increase as modern electronic components used in such devices are developed and improved upon.

Numerous people rely upon or have grown accustomed to usage of electrical consumer devices for business, education, or for other needs. Electronic consumer devices are increasingly portable to accommodate these needs during travels from home or the workplace. The sophistication and capabilities of power supplies for such devices have also improved to meet the requirements of the electronic consumer devices. For example, cost, size, and capacity are some product characteristics which have been improved for the portable power supplies for electronic applications. There is a desire to enhance these and other design parameters of portable power supplies to accommodate increasing popularity and power requirements of the modern electronic consumer devices.

### BRIEF DESCRIPTION OF THE DRAWINGS

Preferred embodiments of the invention are described below with reference to the following accompanying drawings.

FIG. 1 is a functional block diagram of an exemplary electrical power system according to one embodiment.

FIG. 2 is a functional block diagram illustrating details of an exemplary electrical power source apparatus according to one embodiment.

FIG. 3 is a map illustrating how FIGS. 3A-3C are to be assembled.

FIGS. 3A-3C, once assembled, are a schematic diagram illustrating exemplary circuitry of one embodiment of the electrical power source apparatus.

### DETAILED DESCRIPTION OF THE PREFERRED EMBODIMENTS.

This disclosure of the invention is submitted in furtherance of the constitutional purposes of the U.S. Patent Laws “to promote the progress of science and useful arts” (Article 1, Section 8).

The reader is referred to a co-pending U.S. patent application, having Ser. No. 10/071,850, filed Feb. 8, 2002, entitled “Electrical Power Source Apparatuses, Circuits, Electrochemical Device Charging Methods, and Methods of Charging a Plurality of Electrochemical Devices,” listing John Cummings as the inventor, the teachings of which are incorporated herein by reference and which also relate to electrical energy storage systems and methods.

According to one embodiment, an electrical power source apparatus comprises a charge switching device configured in an enabled mode of operation to apply electrical energy from a power node to a plurality of electrochemical devices to charge the electrochemical devices, wherein the charge switching device is further configured in a disabled mode of operation to electrically isolate the electrochemical devices from the power node, a plurality of shunting paths individually configured to shunt electrical energy around a respective one of the electrochemical devices, and wherein the shunting paths are provided in a disengaged operational mode corresponding to the enabled mode of operation of the charge switching device and in an engaged operational mode corresponding to the disabled mode of operation of the charge switching device.

According to another embodiment, an electrical power source apparatus comprises a plurality of shunting paths individually configured to shunt electrical energy around a respective one of a plurality of electrochemical devices and a control system configured to monitor a state of charge of individual ones of the electrochemical devices and to provide the shunting paths in a disengaged operational mode responsive to the states of charge of the electrochemical devices being less than a defined state of charge and to provide at least one of the shunting paths in an engaged operational mode responsive to at least one of the electrochemical devices having the defined state of charge.

According to yet another embodiment, an electrical power source apparatus comprises plural electrochemical means for storing electrical energy, plural shunting paths corresponding to respective ones of the electrochemical means, wherein the shunting paths individually comprise shunting means for selectively shunting a current around the respective one of the electrochemical means, and wherein the shunting paths individually further comprise switching means coupled in series with the shunting means of the respective shunting paths, and wherein the switching means comprise means for selectively providing the respective shunting path in engaged and disengaged operational modes responsive to a state of charge of at least one of the electrochemical means.

According to still another embodiment, a balance circuit comprises a plurality of nodes configured to couple with a plurality of electrochemical devices, and a plurality of shunting paths coupled with the nodes and individually configured to shunt electrical energy from at least a respective one of the electrochemical devices, wherein the shunting paths individually comprise a shunt switching device configured to provide the respective shunting path in an engaged operational mode wherein shunting of the electrical energy may occur and to provide the respective shunting path in a disengaged operational mode wherein shunting of the electrical energy is disabled, and a shunt device coupled in series with the shunt switching device and configured to enable shunting of the electrical energy during the engaged operational mode responsive to an electrical characteristic of the respective electrochemical device exceeding a threshold.

According to an additional embodiment, an electrical power source operational method comprises storing electrical energy using a plurality of electrochemical devices, charging the electrochemical devices, providing a plurality of shunting paths configured to shunt electrical energy around respective ones of the electrochemical devices, providing the shunting paths in a disengaged operational mode during the charging, monitoring a state of charge of individual ones of the electrochemical devices, and providing at least one of the shunting paths in an engaged operational mode to shunt electrical energy around at least one of the electrochemical devices responsive to the monitoring.

According to still another embodiment, an electrochemical device charging method comprises applying electrical energy to a plurality of electrochemical devices to charge the electrochemical devices, shunting electrical energy around the electrochemical devices using a plurality of respective shunt devices of a plurality of respective shunting paths provided in engaged operational modes, controlling a plurality of switching devices of the shunting paths to provide the engaged operational modes of the shunting paths during the shunting, and controlling the switching devices to provide the shunting paths in disengaged operational modes at moments in time other than during the shunting.

According to an additional embodiment, an electrical power source operational method comprises storing electrical energy using a plurality of electrochemical devices, charging the electrochemical devices at a first moment in time, disabling the charging corresponding to a second moment in time, shunting at least some of the applied electrical energy around at least one of the electrochemical devices using a respective shunting path provided in an engaged operational mode and corresponding to the second moment in time, and providing the shunting path in a disengaged operational mode corresponding to the first moment in time.

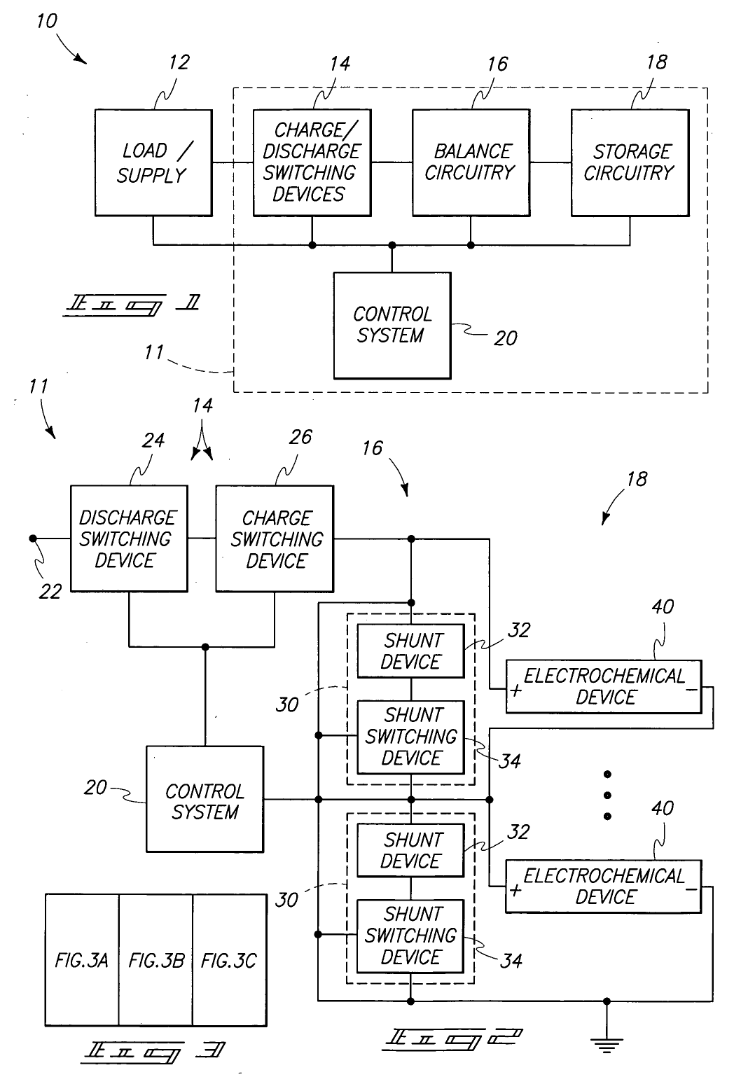

FIG. 1 illustrates exemplary components of an exemplary power system 10 configured to store electrical energy, charge and/or maintain one or more electrochemical device and/or supply electrical energy stored using the one or more electrochemical device to a load. In the exemplary power system 10 illustrated in FIG. 1, a load and/or supply 12, charge/discharge switching devices 14, balance circuitry 16, storage circuitry 18 and control system 20 are provided. Switching devices 14, balance circuitry 16, storage circuitry 18 and control system 20 may be referred to as an electrical power source apparatus 11 in one embodiment. Other configurations of system 10 and apparatus 11 are possible.

It is to be understood that one or more of the depicted exemplary components of the power source apparatus 11 may be implemented within a single self-contained package, such as a battery pack. For example, in one configuration, switching devices 14, balance circuitry 16, storage circuitry 18 and control system 20 are implemented within a single housing (not shown), such as a battery pack housing. In another arrangement, balance circuitry 16, storage circuitry 18, and control system 20 are provided within a single package. In yet another alternative configuration, storage circuitry 18 is provided within a battery pack or other housing. Other battery pack configurations are possible including more, less and/or alternative circuit components.

The components provided within a single housing containing storage circuitry 18 may be configured to removably and electrically couple with external components including load and/or supply 12, switching devices 14, balance circuitry 16 and/or control system 20 depending upon which components are provided within the housing of the given configuration.

Storage circuitry 18 may comprise a plurality of rechargeable electrochemical storage devices. In a given example, the housing containing storage circuitry 18 may be coupled with a supply 12 at a first moment in time to implement charging of storage circuitry 18. Supply 12 may be implemented as any convenient source of electrical power, such as a utility line, generator, alternator, etc. If supply 12 is implemented as an alternating current supply, a rectifier (not shown) may be utilized to provide direct current electrical energy to charge storage circuitry 18.

Following charging of storage circuitry 18, the housing containing the at least partially charged storage circuitry 18 may be coupled with a load 12 at a second moment in time to supply operational electrical energy to the load 12. Exemplary loads 12 include a mobile telephone, personal digital assistant (PDA), notebook computer or any other device configured to utilize electrical energy, including devices which are easily portable for use by an individual. Removable electrical couplings may be implemented using direct contacts or any other appropriate configurations. In some embodiments, apparatus 11 may be simultaneously coupled with a supply and a load to charge storage circuitry 18 and provide electrical energy to the load at the same moment in time.

Charge/discharge switching devices 14 are configured to provide selective electrical coupling of storage circuitry 18 with a load and/or supply 12. In one arrangement, switching devices 14 include a charge switching device and a discharge switching device coupled in series intermediate load/supply 12 and storage circuitry 18. Exemplary switching devices include field effect transistors (FETs).

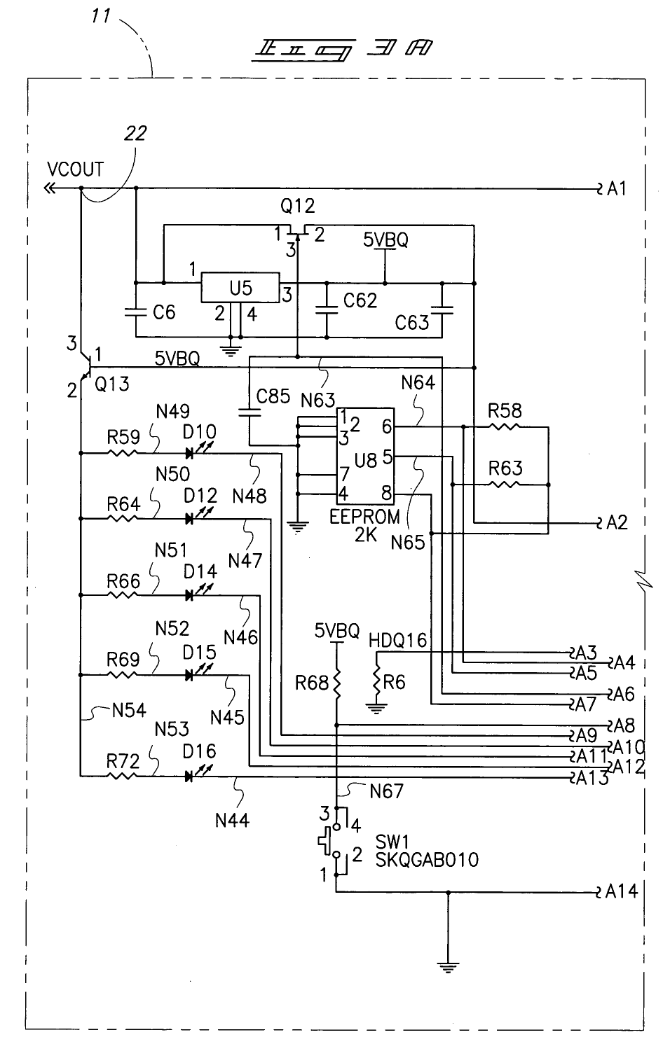

Balance circuitry 16 is arranged to provide electrical charging and/or maintenance of storage circuitry 18 coupled therewith and responsive to control of control system 20. Further operations of an exemplary balance circuitry 16 are discussed below with reference to FIG. 2.

Storage circuitry 18 is configured to store electrical energy for use in appropriate loads comprising electrical devices. In an exemplary embodiment, storage circuitry 18 is implemented as one or more electrochemical device arranged to form a battery. An exemplary configuration of storage circuitry 18 comprising a plurality of cells arranged in series is discussed below with reference to the exemplary power source apparatus 11 of FIG. 2. Other configurations are possible.

Control system 20 is configured to monitor and control charging, discharging and/or maintenance operations of storage circuitry 18. For example, control system 20 may be embodied as a gas gauge controller. In one embodiment, control system 20 includes processing circuitry configured to process executable instructions to implement control operations. In another embodiment, control system 20 may be implemented entirely within hardware. Other control system configurations are possible.

Control system 20 may also include digital storage circuitry (not shown) configured to store electronic data and/or programming such as executable instructions (e.g., software and/or firmware), data, or other digital information and may include processor-usable media. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

FIG. 2 depicts an exemplary configuration of electrical power source apparatus 11. Other configurations are possible.

The exemplary switching device circuitry 14 of the embodiment of FIG. 2 includes a discharge switching device 24 and a charge switching device 26. Switching devices 24, 26 are coupled in series intermediate a power node 22 and storage circuitry 18. Power node 22 may comprise a positive terminal to be coupled with a supply or load (not shown in FIG. 2) during charging and discharging operations.

Switching devices 24, 26 operate in plural modes of operation including open and closed circuit modes of operation responsive to control of control system 20 in one arrangement. For example, in an enabled mode, charge switching device 26 operates in a closed circuit mode to apply electrical energy from power node 22 to electrochemical devices 40 to charge devices 40. In a disabled mode, charge switching device 26 operates in an open circuit mode to isolate power node 22 and electrochemical devices 40.

Balance circuitry 16 comprises a plurality of shunting paths 30. In the depicted exemplary embodiment, the number of shunting paths 30 corresponds to the number of electrochemical devices 40. As illustrated, shunting paths 30 may be individually coupled with a positive terminal and a negative terminal of a respective electrochemical device 40 and configured to shunt electrical energy around or from the respective electrochemical device 40.

In the depicted embodiment, individual ones of shunting paths 30 comprise a shunt device 32 coupled in series with a switching device 34. Shunt devices 32 comprise passive shunt devices in an exemplary embodiment. In passive configurations, devices 32 implement shunting operations without control from control system 20. For example, shunt devices 32 implemented as passive shunt devices may comprise breakdown devices. Exemplary breakdown devices are zener diodes 32 in but one possible configuration. Shunt devices 32 operate in an open circuit mode of operation below a voltage threshold and a closed circuit mode of operation above the voltage threshold. Some configurations of shunt devices 32 (e.g., zener diodes) may leak current at voltages below the voltage threshold.

Switching devices 34 may comprise field effect transistors (FETs) in one embodiment. Control system 20 is arranged to control the operation of switching devices 34 between open and closed circuit modes of operation. For example, in one embodiment, control system 20 is configured to control devices 34 responsive to monitoring of electrical characteristics of devices 40. In one embodiment, provision of switching devices 34 in open and closed circuit modes of operation provide the respective shunting paths 30 comprising the switching devices 34 in disengaged and engaged operational modes, respectively. If appropriate (e.g., shunt device 32 is conducting), shunting paths 30 may individually shunt electrical energy in the engaged operational mode, while shunting paths 30 do not shunt electrical energy in the disengaged operational mode in one arrangement.

The illustrated exemplary arrangement of apparatus 11 includes storage circuitry 18 comprising plural of electrochemical devices 40 coupled in series. Any appropriate number of electrochemical devices 40 may be used corresponding to the implementation of apparatus 11. In one example, storage circuitry 16 may includes four electrochemical devices 40 coupled in series.

In one embodiment of the invention, electrochemical devices 40 individually comprise one or more electrochemical cells. In one embodiment, individual cells of devices 40 have an electrode comprising active material described in detail below. Electrochemical devices 40 implemented as cells individually having electrode active material described below may be individually configured in at least one arrangement to provide a voltage of approximately 3.7 Volts in a substantially charged state or condition. Other implementations or configurations of devices 40 are possible.

In the exemplary configuration wherein four electrochemical devices 40 are implemented as the below described cells and individually providing approximately 3.7 Volts in a substantially charged state, electrical energy having a charging voltage of approximately 16-20 Volts may be used to charge the storage circuitry 16 (e.g., a charging voltage of 4.3 Volts/cell may be used) and be referred to as charging electrical energy. A current of the charging electrical energy may exceed a current of electrical energy shunted using an individual one of the shunting paths 30 in one embodiment.

Electrochemical devices 40 configured as the below-described exemplary cells impede or inhibit flow of current providing an open-circuit with respect to charging electrical energy once the end-of-charge state is reached (and having a voltage of approximately 3.7 Volts in the described exemplary configuration). From a charging perspective, such inhibition of current flow is the equivalent of applying a maximum charge voltage to the charged electrochemical device 40 of approximately 4.3 Volts/cell and the device may assume the charging voltage of 4.3 Volts in one embodiment. Accordingly, at least one implementation of devices 40 may be charged after obtaining an end-of-charge condition (i.e., overcharged). It is also possible to utilize devices 40 of other configurations than those described above wherein charging of devices 40 is not desired after the devices 40 approach or reach a substantially charged state. Accordingly, the threshold voltage monitored by control system 20 may be less than the end-of-charge voltage of individual devices 40 in some arrangements.

Apparatus 11 is configured in some embodiments to minimize current leakage through one or more shunting paths 30. According to one embodiment, shunt devices 32 may be selectively provided in closed and open circuit configurations to implement balance operations with respect to electrochemical devices 40 or reduce leakage current, respectively.

In one embodiment, control system 20 is configured to monitor electrical characteristics of electrochemical devices 40 and control charge/discharge operations and other operations of apparatus 11 responsive to the monitoring. As described above, control system 20 may control shunt switching devices 34 responsive to the monitoring. In one embodiment, control system 20 monitors a state of charge of individual electrochemical devices 40 and implements the control operations responsive to the monitoring. For example, control system 20 may be configured to compare voltages of individual devices 40 with respect to a voltage threshold (e.g., a voltage threshold of 3.7 Volts corresponding to the end-of-charge voltage of individual ones of devices 40 in one embodiment).

According to one arrangement, control system 20 may control charge switching device 26 and one or more of shunt switching devices 34 responsive to the comparison. Control system 20 may control charge switching device 26 to operate in a closed circuit (i.e., engaged) mode during charging of devices 40 indicated by the respective voltages of devices 40 being below a threshold indicating devices 40 are not substantially charged in one embodiment. Further, control system 20 may control shunt switching devices 34 to operate in an open circuit (i.e., disengaged) mode responsive to the respective voltages of devices 40 being below the threshold. Provision of the shunt switching devices 34 in the open circuit operational mode disengages the respective shunting paths 30 from shunting operations in one arrangement. Disengagement of shunting paths 30 reduces leakage current which otherwise may occur (e.g., through shunt devices 32).

Once control system 20 detects a voltage of one or more of devices 40 exceeding the voltage threshold (i.e., indicating at least one device 40 is substantially charged in one embodiment), control system 20 may disengage charging operations of devices 40. For example, control system 20 may provide charge switching device 26 in an open circuit (e.g., disengaged) mode to disengage the charging operations. Further, control system 20 may control shunt switching devices 34 to operate in a closed circuit (i.e., engaged) mode responsive to the voltage of at least one of devices 40 being above the threshold. Provision of the shunt switching devices 34 in the closed circuit operational mode engages the respective shunting paths 30 permitting shunting operations in one arrangement if shunting is appropriate. If one or more electrochemical devices 40 is substantially fully charged, engaged shunting paths 30 of balance circuitry 16 operate to distribute electrical energy to other electrochemical devices 40 which are not substantially or fully charged or to ground.

While charging is disengaged, shunt devices 32 may operate to shunt electrical energy from at least the respective electrochemical device 40 responsive to a voltage of the respective electrochemical device 40 exceeding a respective voltage threshold. In one embodiment, the shunt devices 32 are configured to shunt the electrical energy responsive to the voltage of the respective electrochemical device 40 exceeding the end-of-charge voltage of the respective device 40. Accordingly, in the described exemplary embodiment, shunt devices 32 implemented as zener diodes may have a breakdown voltage of 3.7 Volts. Other breakdown voltages may be used (e.g., less than the end-of-charge voltage of devices 40) in other embodiments.

In one embodiment, charge switching device 26 may not be immediately disengaged following a voltage of one or more of devices 40 exceeding a voltage threshold (e.g., the end-of-charge voltage) and charging electrical energy may be applied to one or more device 40 after the respective device(s) 40 have reached or exceeded the threshold. In embodiments wherein the threshold monitored by control system 20 is the end-of-charge voltage, a voltage of one or more of electrochemical devices 40 may exceed the end-of-charge voltage of the respective devices 40 for a period of time after the threshold is exceeded and before the energy is shunted using one or more shunting path 30.

According to one operational embodiment, control system 20 may control charge switching device 26 to remain in the disabled operational mode and control shunt switching devices 34 to operate in a closed circuit mode until it is desired to discharge electrical energy from devices 40 to a load at which time charge switching device 26 is controlled to operate in the engaged operational mode and shunt switching devices 34 are controlled to operate in the open circuit mode.

In one embodiment, shunting paths 30 may be provided in open and closed circuit configurations (i.e., respective disengaged and engaged operational modes) corresponding to charge switching device 26 operating in enabled and disabled operational modes, respectively. For example, shunt switching devices 34 may be controlled to operate in closed and open circuit modes responsive to control system 20 controlling charge switching device 26 to operate in disengaged and engaged operational modes, respectively. Other control configurations are possible.

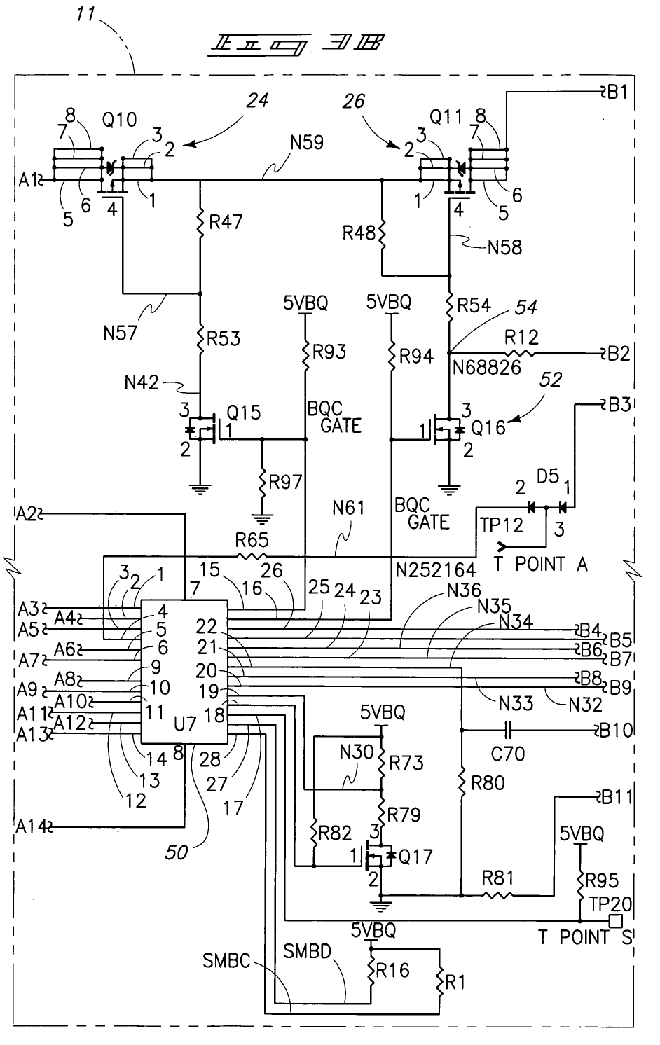

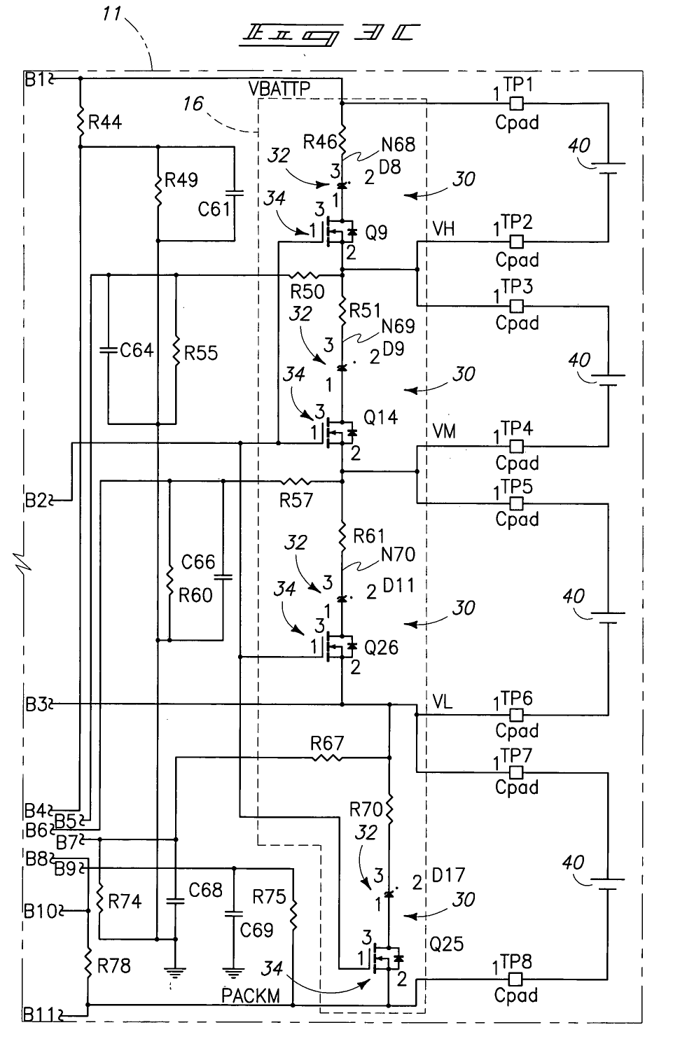

Referring to FIGS. 3A-3C, exemplary circuitry of apparatus 11 is depicted. Other arrangements or configurations of apparatus 11 are possible.

Control system 20 may be implemented using a gas gauge 50 and supporting circuitry in the depicted embodiment. Discharge and charge switching devices 24, 26 operate to selectively couple and isolate power node 22 and balance circuitry 16 in the depicted embodiment. Control system 20 including gas gauge 50 may control switches 24, 26 as described above. For example, gas gauge 50 of control system 20 may monitor voltages of individual electrochemical devices 40 using nodes VBATTP, VH, VM, and VL. If one or more of devices 40 has a voltage above a monitored threshold, control system 20 may operate to disengage charging operations and engage the shunting paths 30.

In the illustrated embodiment, charge switching device 26 is engaged during charging operations while shunt switching devices 34 are disengaged which disengages shunting paths 30. If one or more of devices 40 has a voltage above a threshold, gas gauge 50 may disable transistor 52 (i.e., provide an open circuit arrangement) causing node 54 to reached a high voltage level which disengages charge switching device 26. Node 54 reaching a high voltage level also operates to provide shunt switching devices 34 in closed circuit operational modes which enable or engage the shunting paths 30. Charge switching device 26 may remain disengaged (and shunt switching devices 34 may remain in closed circuit operational modes) until a discharge operation occurs in one operational embodiment. Other control operations are possible.

Exemplary circuit components of FIGS. 3A-3C are identified in Tables A-F. Other components or configurations may be used in other embodiments.

TABLE A
TRANSISTOR COMPONENTS

| LABEL | MODEL |
|---|---|
| Q9 | 2N7002 SOT23 |
| Q10 | FDS6675 |
| Q11 | FDS6675 |
| Q12 | SST113 JFET |
| Q13 | MMBT3904 SOT23 |
| Q14 | 2N7002 SOT23 |
| Q15 | 2N7002 SOT23 |
| Q16 | 2N7002 SOT23 |
| Q17 | 2N7002 SOT23 |
| Q25 | 2N7002 SOT23 |
| Q26 | 2N7002 SOT23 |

TABLE B
RESISTOR COMPONENTS

| LABEL | VALUE |
|---|---|
| R1 | 100k/1% |
| R6 | 100k/1% |
| R12 | 100k/1% |
| R16 | 100k/1% |
| R44 | 1.5M/1% |
| R46 | 100k/1% |
| R47 | 1.5M/1% |
| R48 | 1.5M/1% |
| R49 | 100k/1% |
| R50 | 1.5M/1% |
| R51 | 100/1% |
| R53 | 330k/1% |
| R54 | 330k/1% |
| R55 | 100k/1% |
| R57 | 698K/1% |
| R58 | 10k/1% |
| R59 | 150/1% |
| R60 | 100k/1% |
| R61 | 100/1% |
| R63 | 10k/1% |
| R64 | 150/1% |
| R65 | 1M/1% |
| R66 | 150/1% |
| R67 | 698k/1% |
| R68 | 100k/1% |
| R69 | 150/1% |
| R70 | 100/1% |
| R72 | 150/1% |
| R73 | 10k/1% |
| R74 | 100k/1% |
| R75 | 1k/1% |
| R78 | 1k/1% |
| R79 | 10k/1% |
| R80 | 1k/1% |
| R81 | 0.1/1% |
| R82 | 100k/1% |
| R93 | 698k/1% |
| R94 | 698k/1% |
| R95 | 698k/1% |
| R97 | 1M/1% |

TABLE C
CAPACITOR COMPONENTS

| LABEL | VALUES | MODEL |
|---|---|---|
| C6 | 0.1 uF/25 V | X7R |
| C61 | 1000 pF/25 V | X7R |
| C62 | 0.1 uF/25 V | X7R |
| C63 | 0.33 uF | |
| C64 | 1000 pF/25 V | X7R |
| C66 | 100 pF/25 V | X7R |
| C68 | 1000 pF/25 V | X7R |
| C69 | 0.1 uF/25 V | X7R |
| C70 | 0.1 uF/25 V | X7R |
| C85 | 0.1 uF/25 V | |

TABLE D
DIODE COMPONENTS

| LABEL | VALUE/MODEL |
|---|---|
| D5 | BAV99 SOT23 |
| D8 | 3.6 V |
| D9 | 3.6 V |
| D10 | LED 0805 Green |
| D11 | 3.6 V |
| D12 | LED 0805 Green |
| D14 | LED 0805 Green |
| D15 | LED 0805 Green |
| D16 | LED 0805 Green |
| D17 | 3.6 V |

TABLE E
IC COMPONENTS

| LABEL | MODEL |
|---|---|
| U5 | LT1121 |
| U7 | BQ2060-E |
| U8 | EEPROM 2K |

TABLE F

| | | | | U8 PIN |
|---|---|---|---|---|
| U5 PIN | U7 PIN | | | CONNECT- |
| CONNECTIONS | CONNECTIONS | | | IONS |
| 1 VIN | 1 HDQ16 | 11 LED 2 | 21 SR2 | 1 A0 |
| 2 GND | 2 ESCL | 12 LED 3 | 22 SR1 | 2 A1 |
| 3 VOUT | 3 ESDA | 13 LED 4 | 23 Vcell 1 | 3 A2 |
| 4 Gpad | 4 RBI | 14 LED 5 | 24 Vcell 2 | 4 GND |
| | 5 REG | 15 DFC | 25 Vcell 3 | 5 SDA |
| | 6 Vout | 16 CFC | 26 Vcell 4 | 6 SCL |
| | 7 VCC | 17 CVON | 27 SMBD | 7 WP |
| | 8 Vss | 18 THON | 28 SMBC | 8 VCC |
| | 9 DISP | 19 TS | | |
| | 10 LED 1 | 20 SRC | | |

Electrode active materials which may be used in an electricity-producing electrochemical cell of electrochemical device 40 are described below in one embodiment. Each electrochemical cell includes a positive electrode, a negative electrode, and an electrolyte in ion-transfer relationship with each electrode. As used herein, the word “include,” and its variants, is intended to be non-limiting, such that recitation of items in a list is not to the exclusion of other like items that may also be useful in the materials, compositions, devices, and methods described herein. A “battery” refers to an arrangement having one or more electricity-producing electrochemical cells (e.g., storage circuitry 18). Two or more electrochemical cells may be combined in parallel or series, or “stacked,” so as to create a multi-cell battery. In the exemplary arrangement of FIGS. 3A-3C, storage circuitry 18 includes four devices 40 individually comprising an electrochemical cell and arranged in series. Other embodiments are possible.

The described exemplary electrode active materials may be used in the negative electrode, the positive electrode, or both electrodes of a cell. Preferably, the active materials are used in the positive electrode (As used herein, the terms “negative electrode” and “positive electrode” refer to the electrodes at which oxidation and reduction occur, respectively, during discharge; during charging, the sites of oxidation and reduction are reversed). The terms “preferred” and “preferably” as used herein refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments.

Electrochemical cells used in apparatus 11 may include alkali metal-containing electrode active material. In one embodiment, the active material is represented by the nominal general formula (I):
[Aₐ,D_{d}]Mₘ(XY₄)ₚZₑ, (I)
wherein:
(i) A is selected from the group consisting of elements from Group I of the Periodic Table, and mixtures thereof, and 0<a≦9;
(ii) D is at least one element with a valence state of ≧2+, and 0≦d≦1;
(iii) M includes at least one redox active element, and 1≦m≦3;
(iv) XY₄ is selected from the group consisting of X′[O₄₋ₓY′ₓ], X′[O_{4-y,}Y′_{2y}], X″S₄, [X_{z}′″,X′_{1-z}]O₄, and mixtures thereof, wherein:
   (a) X′ and X′″ are each independently selected from the group consisting of P, As, Sb, Si, Ge, V, S, and mixtures thereof;
   (b) X″ is selected from the group consisting of P, As, Sb, Si, Ge, V, and mixtures thereof;
   (c) Y′ is selected from the group consisting of a halogen, S, N, and mixtures thereof; and
   (d) 0≦x≦3, 0≦y≦2, 0≦z≦1, and 1≦p≦3; and
(v) Z is OH, a halogen, or mixtures thereof, and 0≦e≦4;
   wherein A, D, M, X, Y, Z, a, d, x, y, z, p and e are selected so as to maintain electroneutrality of the material.

The term “nominal general formula” refers to the fact that the relative proportion of atomic species may vary slightly on the order of 2 percent to 5 percent, or more typically, 1 percent to 3 percent. The composition of A, D, M, XY₄ and Z of general formulas (I) through (V) herein, as well as the stoichiometric values of the elements of the active material, are selected so as to maintain electroneutrality of the electrode active material. The stoichiometric values of one or more elements of the composition may take on non-integer values.

For all embodiments described herein, A is selected from the group consisting of elements from Group I of the Periodic Table, and mixtures thereof (e.g. Aₐ=A_{a-a′}A′_{a′}, wherein A and A′ are each selected from the group consisting of elements from Group I of the Periodic Table and are different from one another, and a′<a). As referred to herein, “Group” refers to the Group numbers (i.e., columns) of the Periodic Table as defined in the current IUPAC Periodic Table. (See, e.g., U.S. Pat. No. 6,136,472, Barker et al., issued Oct. 24, 2000, incorporated by reference herein.) In addition, the recitation of a genus of elements, materials or other components, from which an individual component or mixture of components can be selected, is intended to include all possible sub-generic combinations of the listed components, and mixtures thereof.

In one embodiment, A is selected from the group consisting of Li (Lithium), Na (Sodium), K (Potassium), and mixtures thereof. A may be mixture of Li with Na, a mixture of Li with K, or a mixture of Li, Na and K. In another embodiment, A is Na, or a mixture of Na with K. In one preferred embodiment, A is Li.

A sufficient quantity (a) of moiety A should be present so as to allow all of the “redox active” elements of the moiety M (as defined herein below) to undergo oxidation/reduction. In one embodiment, 0<a≦9. In another embodiment, 0<a≦2. Unless otherwise specified, a variable described herein algebraically as equal to (“=”), less than or equal to (“≦”), or greater than or equal to (“≧”) a number is intended to subsume values or ranges of values about equal or functionally equivalent to said number.

Removal of an amount of A from the electrode active material is accompanied by a change in oxidation state of at least one of the “redox active” elements in the active material, as defined herein below. The amount of redox active material available for oxidation/reduction in the active material determines the amount (a) of the moiety A that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

In general, the amount (a) of moiety A in the active material varies during charge/discharge. Where the active materials are synthesized for use in preparing an alkali metal-ion battery in a discharged state, such active materials are characterized by a relatively high value of “a”, with a correspondingly low oxidation state of the redox active components of the active material. As the electrochemical cell is charged from its initial uncharged state, an amount (b) of moiety A is removed from the active material as described above. The resulting structure, containing less amount of the moiety A (i.e., a-b) than in the as-prepared state, and at least one of the redox active components having a higher oxidation state than in the as-prepared state, while essentially maintaining the original values of the remaining components (e.g. D, M, X, Y and Z). The active materials of this invention include such materials in their nascent state (i.e., as manufactured prior to inclusion in an electrode) and materials formed during operation of the battery (i.e., by insertion or removal of A).

For all embodiments described herein, D is at least one element having an atomic radius substantially comparable to that of the moiety being substituted (e.g. moiety M and/or moiety A). In one embodiment, D is at least one transition metal. Examples of transition metals useful herein with respect to moiety D include, without limitation, Nb (Niobium), Zr (Zirconium), Ti (Titanium), Ta (Tantalum), Mo (Molybdenum), W (Tungsten), and mixtures thereof. In another embodiment, moiety D is at least one element characterized as having a valence state of ≦2+ and an atomic radius that is substantially comparable to that of the moiety being substituted (e.g. M and/or A). With respect to moiety A, examples of such elements include, without limitation, Nb (Niobium), Mg (Magnesium) and Zr (Zirconium). Preferably, the valence or oxidation state of D (VD) is greater than the valence or oxidation state of the moiety (or sum of oxidation states of the elements consisting of the moiety) being substituted for by moiety D (e.g. moiety M and/or moiety A).

While not wishing to be held to any one theory, with respect to moiety A, it is thought that by incorporating a dopant (D) into the crystal structure of the active material, wherein the amount (a) of moiety A initially present in the active material is substituted by an amount of D, the dopant will occupy sites in the active material normally occupied by A, thus substantially increasing the ionic and electrical conductivity of the active material. Such materials additionally exhibit enhanced electrical conductivity, thus reducing or eliminating the need for electrically conductive material (e.g. carbon) in the electrode. Reduction or elimination of carbonaceous materials in secondary electrochemical cells, including those disclosed herein, is desirable because of the long-term deleterious effects carbonaceous materials produce during the operation of the electrochemical cells (e.g. promotion of gas production within the electrochemical cell). Reduction or elimination of the carbonaceous material also permits insertion of a greater amount of active material, thereby increasing the electrochemical cell's capacity and energy density.

Moiety A may be partially substituted by moiety D by aliovalent or isocharge substitution, in equal or unequal stoichiometric amounts. “Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Li⁺ with Mg²⁺).

For all embodiments described herein where moiety A is partially substituted by moiety D by isocharge substitution, A may be substituted by an equal stoichiometric amount of moiety D, whereby the active material is represented by the nominal general formula (II):
[A_{a-f},D_{d}]Mₘ(XY₄)ₚZₑ, (II)
wherein f=d.

Where moiety A of general formula (II) is partially substituted by moiety D by isocharge substitution and d≠f, then the stoichiometric amount of one or more of the other components (e.g. A, M, XY₄ and Z) in the active material is adjusted in order to maintain electroneutrality.

For all embodiments described herein where moiety A is partially substituted by moiety D by aliovalent substitution, moiety A may be substituted by an “oxidatively” equivalent amount of moiety D, whereby the active material is represented by the nominal general formula (III):

$$[ {A}_{a - \frac{f}{{V}^{A}}} , {D}_{\frac{d}{{V}^{D}}} ] {{M}_{m} ( {XY}_{4} )}_{p} {Z}_{e} , \qquad ( III )$$

wherein f=d, V^{A} is the oxidation state of moiety A (or sum of oxidation states of the elements consisting of the moiety A), and V^{D} is the oxidation state of moiety D.

Where moiety A of general formula (III) is partially substituted by moiety D by aliovalent substitution and d≠f, then the stoichiometric amount of one or more of the other components (e.g. A, M, XY₄ and Z) in the active material is adjusted in order to maintain electroneutrality.

In one embodiment, moiety M is partially substituted by moiety D by aliovalent or isocharge substitution, in equal or unequal stoichiometric amounts. In this embodiment, d≧0, wherein moiety A may be substituted by moiety D by aliovalent or isocharge substitution, in equal or unequal stoichiometric amounts. Where moieties M and A are both partially substituted by moiety D, the elements selected for substitution for each moiety may be the same or different from one another.

For all embodiments described herein where moiety M is partially substituted by moiety D by isocharge substitution, M may be substituted by an equal stoichiometric amount of moiety D, whereby M=[Mₘ₋ᵤ,Dᵥ], wherein u=v. Where moiety M is partially substituted by moiety D by isocharge substitution and u≠v, then the stoichiometric amount of one or more of the other components (e.g. A, M, XY₄ and Z) in the active material is adjusted in order to maintain electroneutrality.

For all embodiments described herein where moiety M is partially substituted by moiety D by aliovalent substitution, moiety M may be substituted by an “oxidatively” equivalent amount of moiety D, whereby

$$[ {M}_{m - \frac{u}{{V}^{M}}} , {D}_{\frac{v}{{V}^{D}}} ] ,$$

wherein u=v, V^{M} is the oxidation state of moiety M (or sum of oxidation states of the elements consisting of the moiety M), and V^{D} is the oxidation state of moiety D.

Where moiety M is partially substituted by moiety D by aliovalent substitution and u≠v, then the stoichiometric amount of one or more of the other components (e.g. A, M, XY₄ and Z) in the active material is adjusted in order to maintain electroneutrality.

In this embodiment, moiety M and (optionally) moiety A are each partially substituted by aliovalent or isocharge substitution. While not wishing to be held to any one theory, it is thought that by incorporating a dopant (D) into the crystal structure of the active material in this manner, wherein the stoichiometric values M and (optionally) A are dependent on (reduced by) the amount of dopant provided for each crystallographic site, that the dopant will occupy sites in the active material normally occupied by moiety M and (optionally) moiety A. First, where V^{D}>V^{A}, doping sites normally occupied by A increases the number of available or unoccupied sites for A, thus substantially increasing the ionic and electrical conductivity of the active material. Second, doping the M sites reduces the concentration of available redox active elements, thus ensuring some amount of A remains in the active material upon charge, thereby increasing the structural stability of the active material. Such materials additionally exhibit enhanced electrical conductivity, thus reducing or eliminating the need for electrically conductive material in the electrode.

In all embodiments described herein, moiety M is at least one redox active element. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to moiety M include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium) Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. Also, “include,” and its variants, is intended to be non-limiting, such that recitation of items in a list is not to the exclusion of other like items that may also be useful in the materials, compositions, devices, and methods of this invention.

In one embodiment, moiety M is a redox active element. In one subembodiment, M is a redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, moiety M is a mixture of redox active elements or a mixture of at least one redox active element and at least one non-redox active element. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), Tl (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M=MIₙMIIₒ, wherein 0<o+n≦3 and each of o and n is greater than zero (0≦o,n), wherein MI and MII are each independently selected from the group consisting of redox active elements and non-redox active elements, wherein at least one of MI and MII is redox active. MI may be partially substituted with MII by isocharge or aliovalent substitution, in equal or unequal stoichiometric amounts.

For all embodiments described herein where MI is partially substituted by MII by isocharge substitution, MI may be substituted by an equal stoichiometric amount of MII, whereby M=MIₙ₋ₒMIIₒ. Where MI is partially substituted by MII by isocharge substitution and the stoichiometric amount of MI is not equal to the amount of MII, whereby M=MIₙ₋ₒMIIₚ and o≠p, then the stoichiometric amount of one or more of the other components (e.g. A, D, XY₄ and Z) in the active material is adjusted in order to maintain electroneutrality.

For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A, D, XY₄ and Z) in the active material is adjusted in order to maintain electroneutrality. However, MI may be partially substituted by MII by aliovalent substitution by substituting an “oxidatively” equivalent amount of MII for MI, whereby

$$M = {MI}_{n - \frac{o}{{V}^{MI}}} {MII}_{\frac{o}{{V}^{MII}}} ,$$

wherein V^{NI} is the oxidation state of MI, and V^{MII} is the oxidation state of MII.

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²+, Mo²⁺, Sr²⁺, Sn²⁺, Po²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and MII is selected from the group consisting of Zn²⁺, Cd²⁺, and mixtures thereof. In yet another aspect of this subembodiment, MI is selected from the group consisting of Ti³⁺, V³⁺, Cr³⁺, Mn³⁺, Fe³⁺, Co³⁺, Ni³⁺, Mo³+, Nb³⁺, and mixtures thereof, and MII is selected from the group consisting of Sc³⁺, Y³⁺, B³⁺, Al³⁺, Ga³⁺, In³⁺, and mixtures thereof.

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²+, Mo²⁺, Sr²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³+, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is a 3+ oxidation state redox active element selected from the group specified immediately above, and MII is selected from the group consisting of alkali metals, Cu¹⁺, Ag¹⁺ and mixtures thereof.

In another embodiment, M=M1_{q}M2ᵣM3ₛ, wherein:
(a) M1 is a redox active element with a 2+ oxidation state;
(b) M2 is selected from the group consisting of redox and non-redox active elements with a 1+ oxidation state;
(c) M3 is selected from the group consisting of redox and non-redox active elements with a 3+ oxidation state; and
(d) at least one of p, q and r is greater than 0, and at least one of M1, M2, and M3 is redox active.

In one subembodiment, M1 is substituted by an equal amount of M2 and/or M3, whereby q=q-(r+s). In this subembodiment, then the stoichiometric amount of one or more of the other components (e.g. A, XY₄, Z) in the active material is adjusted in order to maintain electroneutrality.

In another subembodiment, M¹ is substituted by an “oxidatively” equivalent amount of M² and/or M³, whereby

$$M = {M1}_{q - \frac{r}{{V}^{M1}} - \frac{s}{{V}^{M1}}} {M2}_{\frac{r}{{V}^{M2}}} {M3}_{\frac{s}{{V}^{M3}}} ,$$

wherein V^{M1} is the oxidation state of M1, V^{M2} is the oxidation state of M2, and V^{M3} is the oxidation state of M3.

In one subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Be²⁺, Mg²⁺, Ca²⁺, Sr²⁺, Ba²⁺, Zn²⁺, Cd²⁺, Ge²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Sr²⁺, Sn²⁺, Pb²⁺, and mixtures thereof; M2 is selected from the group consisting of Cu¹⁺, Ag¹⁺, and mixtures thereof; and M3 is selected from the group consisting of Sc³⁺, Y³⁺, B³⁺, Al³⁺, Ga³⁺, In³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In all embodiments described herein, moiety XY₄ is a polyanion selected from the group consisting of X′[O_{4-x,}Y′ₓ], X′[O_{4-y,}Y′_{2y}], X″S₄, [X_{z}′″,X′_{1-z}]O₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) Y′ is selected from the group consisting of a halogen, S, N, and mixtures thereof; and
(d) 0≦x≦3, 0≦y≦2,and 0≦z≦1.

In one embodiment, 1≦p≦3. In one subembodiment, p=1. In another subembodiment, p=3.

In one embodiment, XY₄ is selected from the group consisting of X′O₄₋ₓY′ₓ, X′O_{4-y}Y′_{2y}, and mixtures thereof, and x and y are both 0. Stated otherwise, XY₄ is a polyanion selected from the group consisting of PO₄, SiO₄, GeO₄, VO₄, AsO₄, SbO₄, SO₄, and mixtures thereof. Preferably, XY₄ is PO₄ (a phosphate group) or a mixture of PO₄ with another anion of the above-noted group (i.e., where X′ is not P, Y′ is not O, or both, as defined above). In one embodiment, XY₄ includes about 80% or more phosphate and up to about 20% of one or more of the above-noted anions.

In another embodiment, XY₄ is selected from the group consisting of X′[O_{4-x,}Y′ₓ], X′[O_{4-y,}Y′_{2y}], and mixtures thereof, and 0<x≦3 and 0<y≦2, wherein a portion of the oxygen (O) in the XY₄ moiety is substituted with a halogen, S, N, or a mixture thereof.

In all embodiments described herein, moiety Z (when provided) is selected from the group consisting of OH (Hydroxyl), a halogen, or mixtures thereof. In one embodiment, Z is selected from the group consisting of OH, F (Fluorine), Cl (Chlorine), Br (Bromine), and mixtures thereof. In another embodiment, Z is OH. In another embodiment, Z is F, or a mixture of F with OH, Cl, or Br. Where the moiety Z is incorporated into the active material, the active material may not take on a NASICON or olivine structural where p=3 or d=1, respectively. It is quite normal for the symmetry to be reduced with incorporation of, for example, halogens.

The composition of the electrode active material, as well as the stoichiometric values of the elements of the composition, are selected so as to maintain electroneutrality of the electrode active material. The stoichiometric values of one or more elements of the composition may take on non-integer values. Preferably, the XY₄ moiety is, as a unit moiety, an anion having a charge of −2, −3, or −4, depending on the selection of X′, X″, X′″ Y′, and x and y. When XY₄ is a mixture of polyanions such as the preferred phosphate/phosphate substitutes discussed above, the net charge on the XY₄ anion may take on non-integer values, depending on the charge and composition of the individual groups XY₄ in the mixture.

In one particular embodiment, the electrode active material has an orthorhombic-dipyramidal crystal structure and belongs to the space group Pbnm (e.g. an olivine or triphylite material), and is represented by the nominal general formula (II):
[Aₐ,D_{d}]MₘXY₄Zₑ, (IV)
wherein:
(a) the moieties A, D, M, X, Y and Z are as defined herein above;
(b) 0<a≦2, 0≦d≦1, 1<m≦2, and 0<e≦1; and
(c) the components of the moieties A, D, M, X, Y, and Z, as well as the values for a, d, m and e, are selected so as to maintain electroneutrality of the compound.

In one particular subembodiment, A of general formula (IV) is Li, 0.5<a≦1.5, M=MIₙ₋ₚMIIₒ, wherein o=p, 0.5<n≦1.5, 0<o≦0.1, MI is a 2+ oxidation state redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺ (preferably Fe²⁺), MII is selected from the group consisting of Be²⁺, Mg²⁺, Ca²⁺, Sr²⁺, Ba²⁺, Zn²⁺, Cd²⁺, Ge²⁺, and mixtures thereof (preferably Mg²⁺ or Ca²⁺), XY₄═PO₄, and e=0.

In another particular subembodiment, A of general formula (IV) is Li, 0<a≦1, M=MIₙ₋ₚMIIₒ, wherein o=p, 0<o≦0.5, MI is Fe²⁺, MII is selected from the group consisting of Be²⁺, Mg²⁺, Ca²⁺, Sr²⁺, Ba²⁺, and mixtures thereof (preferably Mg²⁺ or Ca²⁺), XY₄═PO₄, and d,e=0.

In another particular embodiment, the electrode active material has a rhombohedral (space group R-3) or monoclinic (space group Pbcn) NASICON structure, and is represented by the nominal general formula (V):
[Aₐ,D_{d}]Mₘ(XY₄)₃Zₑ, (V)
wherein:
(a) the moieties A, D, M, X, Y and Z are as defined herein above;
(b) 0<a≦5, 0d≦1; 1<m≦3,and 0<e≦4; and
(c) the components of the moieties A, D, M, X, Y, and Z, as well as the values for a, d, m and e, are selected so as to maintain electroneutrality of the compound.

In one particular subembodiment, A of general formula (V) is Li, M is selected from the group consisting of Ti³⁺, V³⁺, Cr³⁺, Mn³⁺, Fe³⁺, Co³⁺, Ni³⁺, Mo³⁺, Nb³⁺, and mixtures thereof (preferably V³⁺), XY₄═PO₄, and e=0. In another particular subembodiment, A of general formula (V) is Li, M is selected from the group consisting of Ti³⁺, V³⁺, Cr³⁺, Mn³⁺, Fe³⁺, Co³⁺, Ni³⁺, Mo³⁺, Nb³⁺, and mixtures thereof (preferably V³⁺), XY₄═PO₄, and d,e=0.

The following applications describe additional details of active materials and method of forming active materials and compounds according to exemplary aspects: International Publication No. WO01/54212, entitled “Lithium-Based Electrochemically Active Materials And Preparation Thereof,” published Jul. 26, 2001, listing Jeremy Barker and M. Yazid Saidi as inventors; International Publication No. WO98/12761, entitled “Lithium-Containing, Lithium-Intercalating Phosphates And Their Use As The Positive Or Negative Electrode Material In A Lithium Secondary Battery,” published Mar. 26, 1998, listing M. Yazid Saidi and Jeremy Barker as inventors; International Publication No. WO 00/01024, entitled “Lithium-Containing Silicon/Phosphates, Method Of Preparation, And Uses Thereof,” published Jan. 6, 2000, listing Jeremy Barker and M. Yazid Saidi as inventors; International Publication No. WO00/31812, entitled “Lithium-Based Phosphates For Use In Lithium Ion Batteries And Method Of Preparation,” published Jun. 2, 2000, listing Jeremy Barker and M. Yazid Saidi as inventors; International Publication No. WO00/57505, entitled “Lithium-Containing Phosphate Active Materials,” published Sep. 28, 2000, listing Jeremy Barker as inventor; International Publication No. WO02/44084, entitled “Methods Of Making Lithium Metal Compounds Useful As Cathode Active Materials,” published Jun. 6, 2002, listing Jeremy Barker and M. Yazid Saidi as inventors; International Publication No. WO03/085757, entitled “Batteries Comprising Alkali-Transition Metal Phosphates And Preferred Electrolytes,” published Oct. 16, 2003, listing M. Yazid Saidi and Haitao Huang as inventors; International Publication No. WO03/085771, entitled “Alkali-Iron-Cobalt Phosphates And Related Electrode Active Materials,” published Oct. 16, 2003, listing M. Yazid Saidi and Haitao Huang as inventors; International Publication No. WO03/088383, entitled “Alkali-Transition Metal Phosphates Having A+3 Valence Non-Transition Element And Related Electrode Active Materials,” published Oct. 23, 2003, listing M. Yazid Saidi and Haitao Huang as inventors; U.S. Pat. No. 6,528,033, issued Mar. 4, 2003, entitled “Method Of Making Lithium Containing Materials,” listing Jeremy Barker, M. Yazid Saidi, and Jeffrey Swoyer as inventors; U.S. Pat. No. 6,387,568, issued May 14, 2002, entitled “Lithium Metal Flurophosphate Materials And Preparation Thereof,” listing Jeremy Barker, M. Yazid Saidi, and Jeffrey Swoyer as inventors; U.S. Publication No. 2003/0027049, published Feb. 2, 2003, entitled “Alkali/Transition Metal Halo-And Hydroxyl-Phosphates And Related Electrode Materials,” listing Jeremy Barker, M. Yazid Saidi, and Jeffrey Swoyer as inventors; U.S. Publication No. 2002/0192553, published Dec. 19, 2002, entitled “Sodium Ion Batteries,” listing Jeremy Barker, M. Yazid Saidi, and Jeffrey Swoyer as inventors; U.S. Publication No. 2003/0170542, published Sep. 11, 2003, entitled “Alkali Transition Metal Phosphates And Related Electrode Active Materials,” listing Jeremy Barker, M. Yazid Saidi, and Jeffrey Swoyer as inventors; and U.S. patent application Ser. No. 09/484,799, entitled “Lithium-Based Active Materials and Preparation Thereof”, listing Jeremy Barker as an inventor, filed Jan. 18, 2000, now U.S. Publication No. 2003/0129492, the teachings of all of which are incorporated herein by reference.

According to one aspect for forming an electrode, the active material may be combined with a polymeric binder (e.g. polyvinylidene difluoride (PVdF) and hexafluoropropylene (HFP)) in order to form a cohesive mixture. The mixture is then placed in electrical communication with a current collector which, in turn, provides electrical communication between the electrode and an external load. The mixture may be formed or laminated onto the current collector, or an electrode film may be formed from the mixture wherein the current collector is embedded in the film. Suitable current collectors include reticulated or foiled metals (e.g. aluminum, copper and the like). An electrically conductive diluent or agent (e.g. a carbon such as carbon black and the like) may be added to the mixture so as to increase the electrical conductivity of the electrode. In one embodiment, the electrode material is pressed onto or about the current collector, thus eliminating: the need for the polymeric binder. In one embodiment, the electrode contains 5 to 30% by weight electrically conductive agent, 3 to 20% by weight binder, and the remainder being the electrode active material.

To form an electrochemical cell, a solid electrolyte or an electrolyte-permeable separator is interposed between the electrode and a counter-electrode. In one embodiment, the electrolyte contains a solvent selected from the group consisting of the electrolyte comprises a lithium salt and a solvent selected from the group consisting of dimethyl carbonate (DMC), diethylcarbonate (DEC), dipropylcarbonate (DPC), ethylmethylcarbonate (EMC), ethylene carbonate (EC), propylene carbonate (PC), butylene carbonate, lactones, esters, glymes, sulfoxides, sulfolanes, and mixtures thereof; and 5 to 65% by weight of an alkali metal salt. Preferred solvent combinations include EC/DMC, EC/DEC, EC/DPC and EC/EMC. In one embodiment, the counter-electrode contains an intercalation active material selected from the group consisting of a transition metal oxide, a metal chalcogenide, carbon (e.g. graphite), and mixtures thereof. Counter electrodes, electrolyte compositions, and methods for making the same, among those useful herein, are described in U.S. Pat. No. 5,700,298, Shi et al., issued Dec. 23, 1997; U.S. Pat. No. 5,830,602, Barker et al., issued Nov. 3, 1998; U.S. Pat. No. 5,418,091, Gozdz et al., issued May 23, 1995; U.S. Pat. No. 5,508,130, Golovin, issued Apr. 16, 1996; U.S. Pat. No. 5,541,020, Golovin et al., issued Jul. 30, 1996; U.S. Pat. No. 5,620,810, Golovin et al., issued Apr. 15, 1997; U.S. Pat. No. 5,643,695,Barker et al., issued Jul. 1, 1997; U.S. Pat. No. 5,712,059, Barker et al., issued Jan. 27, 1997; U.S. Pat. No. 5,851,504, Barker et al., issued Dec. 22, 1998; U.S. Pat. No. 6,020,087, Gao, issued Feb. 1, 2001; and U.S. Pat. No. 6,103,419, Saidi et al., issued Aug. 15, 2000; all of which are incorporated by reference herein.

Additional details of electrochemical cells composed of electrodes (including polymer-type stacked cells and cylindrical-type cells), electrolytes and other materials, among those useful herein, are described in the following documents, all of which are incorporated by reference herein: U.S. Pat. No. 4,668,595, Yoshino et al., issued May 26, 1987; U.S. Pat. No. 4,792,504, Schwab et al., issued Dec. 20, 1988; U.S. Pat. No. 4,830,939, Lee et al., issued May 16, 1989; U.S. Pat. No. 4,935,317, Fauteaux et al., issued Jun. 19, 1980; U.S. Pat. No. 4,990,413, Lee et al., issued Feb. 5, 1991; U.S. Pat. No. 5,037,712, Shackle et al., issued Aug. 6, 1991; U.S. Pat. No. 5,262,253, Golovin, issued Nov. 16, 1993; U.S. Pat. No. 5,300,373, Shackle, issued Apr. 5, 1994; U.S. Pat. No. 5,399,447, Chaloner-Gill, et al., issued Mar. 21,1995; U.S. Pat. No. 5,411,820, Chaloner-Gill, issued May 2, 1995; U.S. Pat. No. 5,435,054, Tonder et al., issued Jul. 25, 1995; U.S. Pat. No. 5,463,179, Chaloner-Gill et al., issued Oct. 31, 1995; U.S. Pat. No. 5,482,795, Chaloner-Gill., issued Jan. 9, 1996; U.S. Pat. No. 5,660,948, Barker, issued Sep. 16, 1995; U.S. Pat. No. 5,869,208, Miyasaka, issued Feb. 9, 1999; U.S. Pat. No. 5,882,821, Miyasaka, issued Mar. 16, 1999; U.S. Pat. No. 5,616,436, Sonobe. et al., issued Apr. 1, 1997; and U.S. Pat. No. 6,306,215, Larkin, issued Oct. 23, 2001.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. An electrical power source apparatus comprising:
a charge switching device configured in an enabled mode of operation to apply electrical energy from a power node to a plurality of electrochemical devices to charge the electrochemical devices, wherein the charge switching device is further configured in a disabled mode of operation to electrically isolate the electrochemical devices from the power node;
a plurality of shunting paths individually configured to shunt electrical energy around a respective one of the electrochemical devices; and
wherein the shunting paths are provided in a disengaged operational mode corresponding to the enabled mode of operation of the charge switching device and in an engaged operational mode corresponding to the disabled mode of operation of the charge switching device.

2. The apparatus of claim 1 wherein the shunting paths individually comprise a shunt switching device configured to configured to provide the engaged and disengaged operational modes of the respective shunting path.

3. The apparatus of claim 2 wherein the shunt switching devices are controlted to provide the engaged operational mode responsive to a voltage of an individual one of the electrochemical devices exceeding one threshold.

4. The apparatus of claim 3 wherein the shunting paths individually comprise a shunt device coupled in series with the shunt switching device of the respective shunting path, and wherein the shunt devices are individually configured to shunt electrical energy from a respective one of the electrochemical devices responsive to a voltage of the respective one of the electrochemical devices exceeding another threshold.

5. The apparatus of claim 4 wherein the one and the another threshold correspond to an end-of-charge voltage of the electrochemical devices.

6. The apparatus of claim 4 wherein the shunt devices comprise passive devices configured to switch between open and closed circuit modes of operation without external control signals.

7. The apparatus of claim 1 wherein the shunting paths individually comprise a shunt device comprising a zener diode.

8. The apparatus of claim 1 wherein the electrical energy for charging the electrochemical devices has a current greater than a current of electrical energy shunted using an individual one of the shunting paths.

9. The apparatus of claim 1 further comprising the electrochemical devices individually configured to store electrical energy.

10. The apparatus of claim 9 wherein the electrochemical devices individually comprise an electrode active material represented by the general formula:
AₐMPO₄,
wherein:
(i) A is Li, and 0<a≦1; and
(ii) M=MIₙ₋ₚMIIₒ, wherein o=p, 0<o≦0.5, MI is iron (Fe), and MII is selected from the group consisting of Be²⁺, Mg²⁺, Ca²⁺, Sr²⁺, Ba²⁺, and mixtures thereof.

11. The apparatus of claim 9 wherein the electrochemical devices individually comprise an electrode active material represented by the general formula:
AₐMₘ(PO₄)₃,
wherein:
(i) A is Li, and 0<a≦5, and
(ii) M is selected from the group consisting of Ti³⁺, V³⁺, Cr³⁺, Mn³⁺, Fe³⁺, Co³⁺, Ni³⁺, Mo³⁺, Nb³⁺, and mixtures thereof, and 1<m≦3; and
wherein A, M, a and m are selected so as to maintain electroneutrality of the electrode active material.

12. The apparatus of claim 11 wherein M is V³⁺.

13. The apparatus of claim 9 wherein the electrochemical devices are individually configured to assume an open circuit condition in a substantially charged state.

14. The apparatus of claim 9 wherein the electrochemical devices are individually configured to assume a voltage in a substantially charged state substantially equal to a voltage of the electrical energy used to charge the electrochemical devices.

15. The apparatus of claim 1 further comprising a control system configured to monitor individual ones of the electrochemical devices and to control shunt switching devices of the shunting paths responsive to the monitoring.

16. The apparatus of claim 15 wherein the control system is configured to control the charge switching device to operate in the disabled mode of operation and to control the shunt switching devices to operate in a closed circuit mode of operation responsive to at least one of the monitored electrochemical devices having a voltage greater than a threshold.

17. The apparatus of claim 1 wherein the charge switching device applies the electrical energy used to charge the electrochemical devices to at least one of the electrochemical devices after the at least one electrochemical device has assumed a substantially charged state.

18. An electrical power source apparatus comprising:
a plurality of shunting paths individually configured to shunt electrical energy around a respective one of a plurality of electrochemical devices; and
a control system configured to monitor a state of charge of individual ones of the electrochemical devices and to provide the shunting paths in a disengaged operational mode responsive to the states of charge of the electrochemical devices being less than a defined state of charge and to provide at least one of the shunting paths in an engaged operational mode responsive to at least one of the electrochemical devices having at least the defined state of charge.

19. The apparatus of claim 18 wherein the shunting paths comprise shunt switching devices configured to operate in open and closed circuit modes of operation responsive to control of the control system.

20. The apparatus of claim 19 wherein the shunting paths individually comprise a shunt device in series with the shunt switching device of the respective shunting path and configured to shunt electrical energy around a respective electrochemical device having at least a defined voltage.

21. The apparatus of claim 20 wherein the defined voltage is substantially equal to a voltage of one of the electrochemical devices in a substantially charged state.

22. The apparatus of claim 18 wherein the electrical energy for charging the electrochemical devices has a current greater than a current of electrical energy shunted using an individual one of the shunting paths.

23. The apparatus of claim 18 further comprising the electrochemical devices.

24. The apparatus of claim 23 wherein the electrochemical devices individually comprise an electrode active material represented by the general formula:
AₐMPO₄,
wherein:
(i) A is Li, and 0<a≦1; and
(ii) M=MIₙ₋ₚMIIₒ, wherein o=p, 0<o≦0.5, MI is iron (Fe), and MII is selected from the group consisting of Be²⁺, Mg²⁺, Ca²⁺, Sr²⁺, Ba²⁺, and mixtures thereof.

25. The apparatus of claim 23 wherein the electrochemical devices individually comprise an electrode active material represented by the general formula:
AₐMₘ(PO₄)₃,
wherein:
(i) A is Li, and 0<a≦5, and
(ii) M is selected from the group consisting of Ti³⁺, V³⁺, Cr³⁺, Mn³⁺, Fe³⁺, Co³⁺, Ni³⁺, Mo³⁺, Nb³⁺, and mixtures thereof, and 1<m≦3; and
wherein A, M, a and m are selected so as to maintain electroneutrality of the electrode active material.

26. The apparatus of claim 25 wherein M is V³⁺.

27. The apparatus of claim 18 wherein the shunting paths individually comprise a shunt switching device and the control system is configured to control the shunt switching devices to provide the shunting paths in the disengaged and engaged operational modes.

28. The apparatus of claim 18 wherein the control system is configured to control a charge switching device to operate in the disabled mode of operation responsive to at least one of the monitored electrochemical devices reaching a substantially charged state.

29. The apparatus of claim 18 wherein the defined state of charge corresponds to a substantially charged state of individual ones of the electrochemical devices.

30. An electrical power source apparatus comprising:
plural electrochemical means for storing electrical energy;
plural shunting paths corresponding to respective ones of the electrochemical means, wherein the shunting paths individually comprise shunting means for selectively shunting a current around the respective one of the electrochemical means; and
wherein the shunting paths individually further comprise switching means coupled in series with the shunting means of the respective shunting paths, and wherein the switching means comprise means for selectively providing the respective shunting path in engaged and disengaged operational modes responsive to a state of charge of at least one of the electrochemical means.

31. A balance circuit comprising:
a plurality of nodes configured to couple with a plurality of electrochemical devices; and
a plurality of shunting paths coupled with the nodes and individually configured to shunt electrical energy around at least a respective one of the electrochemical devices, wherein the shunting paths individually comprise:
a shunt switching device configured to provide the respective shunting path in an engaged operational mode wherein shunting of the electrical energy may occur and to provide the respective shunting path in a disengaged operational mode wherein shunting of the electrical energy is disabled; and
a shunt device coupled in series with the shunt switching device and configured to enable shunting of the electrical energy during the engaged operational mode responsive to an electrical characteristic of the respective electrochemical device exceeding a threshold.

32. The circuit of claim 31 wherein the shunt device comprises a zener diode.

33. The circuit of claim 31 wherein the shunt switching device is controlled to provide the engaged operational mode corresponding to charging operations of the electrochemical devices and to provide the disengaged operational mode corresponding to disablement of the charging operations.

34. The circuit of claim 31 wherein the shunt device is configured to disable shunting of the respective shunting path responsive to the electrical characteristic of the respective electrochemical device being below the threshold.

35. An electrical power source operational method comprising:
storing electrical energy using a plurality of electrochemical devices;
charging the electrochemical devices;
providing a plurality of shunting paths configured to shunt electrical energy around respective ones of the electrochemical devices;
providing the shunting paths in a disengaged operational mode during the charging;
monitoring a state of charge of individual ones of the electrochemical devices; and
providing at least one of the shunting paths in an engaged operational mode to shunt electrical energy around at least one of the electrochemical devices responsive to the monitoring.

36. The method of claim 35 wherein the providing the shunting paths in the engaged and disengaged operational modes comprise using shunt switching devices of the shunting paths.

37. The method of claim 36 further comprising, using the shunt switching devices, reducing leakage current through shunt devices coupled in series with respective ones of the shunt switching devices of the shunting paths.

38. The method of claim 37 wherein the shunt devices individually comprise a zener diode.

39. The method of claim 35 wherein the at least one shunting path is provided in the engaged operational mode responsive to the at least one electrochemical device having at least a defined state of charge.

40. The method of claim 35 wherein the charging comprise charging using electrical energy having a current greater than a current of the shunted electrical energy.

41. The method of claim 35 wherein the storing comprises using the electrochemical devices individually comprising an electrode active material represented by the general formula:
AₐMPO₄,
wherein:
(i) A is Li, and 0<a≦1; and
(ii) M=MIₙ₋ₚMIIₒ, wherein o=p, 0<o≦0.5, MI is iron (Fe), and MII is selected from the group consisting of Be²⁺, Mg²⁺, Ca²⁺, Sr²⁺, Ba²⁺, and mixtures thereof.

42. The method of claim 35 wherein the storing comprises using the electrochemical devices individually comprising an electrode active material represented by the general formula:
AₐMₘ(PO₄)₃,
wherein:
(i) A is Li, and 0<a≦5, and
(ii) M is selected from the group consisting of Ti³⁺, V³⁺, Cr³⁺, Mn³⁺, Fe³⁺, Co³⁺, Ni³⁺, Mo³⁺, Nb³⁺, and mixtures thereof, and 1<m≦3; and
wherein A, M, a and m are selected so as to maintain electroneutrality of the electrode active material.

43. The method of claim 42 wherein M is V³⁺.

44. The method of claim 35 further comprising disabling the charging corresponding to provision of the at least one shunting path in the engaged operational mode.

45. The method of claim 35 wherein the charging comprises applying electrical energy to at least one of the electrochemical devices after at least one of the electrochemical devices has assumed a substantially charged state.

46. An electrochemical device charging method comprising:
applying electrical energy to a plurality of electrochemical devices to charge the electrochemical devices;
shunting electrical energy around the electrochemical devices using a plurality of respective shunt devices of a plurality of respective shunting paths provided in engaged operational modes;
controlling a plurality of shunt switching devices of the shunting paths to provide the engaged operational modes of the shunting paths during the shunting; and
controlling the shunt switching devices to provide the shunting paths in disengaged operational modes at moments in time other than during the shunting.

47. The method of claim 46 wherein the controlling to provide the engaged operational mode comprises controlling responsive to at least one of the electrochemical devices having a defined state of charge.

48. The method of claim 46 wherein the applied electrical energy for charging the electrochemical devices has a current greater than a current of the electrical energy shunted using an individual one of the shunting paths.

49. The method of claim 46 wherein the applying comprises applying the electrical energy to the electrochemical devices individually comprising an electrode active material represented by the general formula:
AₐMPO₄,
wherein:
(i) A is Li, and 0<a≦1; and
(ii) M=MIₙ₋ₚMIIₒ, wherein o=p, 0<o≦0.5, MI is iron (Fe), and MII is selected from the group consisting of Be²⁺, Mg²⁺, Ca²⁺, Sr²⁺, Ba²⁺, and mixtures thereof.

50. The method of claim 46 wherein the applying comprises applying the electrical energy to the electrochemical devices individually comprising an electrode active material represented by the general formula:
AₐMₘ(PO₄)₃,
wherein:
(i) A is Li, and 0<a≦5, and
(ii) M is selected from the group consisting of Ti³⁺, V³⁺, Cr³⁺, Mn³⁺, Fe³⁺, Co³⁺, Ni³⁺, Mo³⁺, Nb³⁺, and mixtures thereof, and 1<m≦3; and
wherein A, M, a and m are selected so as to maintain electroneutrality of the electrode active material.

51. The method of claim 50, wherein M is V³⁺.

52. The method of claim 46 wherein the applying comprises applying the electrical energy to the electrochemical devices after the electrochemical devices have assumed a substantially charged state.

53. An electrical power source operational method comprising:
storing electrical energy using a plurality of electrochemical devices;
charging the electrochemical devices at a first moment in time;
disabling the charging corresponding to a second moment in time;
shunting at least some of the applied electrical energy around at least one of the electrochemical devices using a respective shunting path provided in an engaged operational mode and corresponding to the second moment in time; and
providing the shunting path in a disengaged operational mode corresponding to the first moment in time.

54. The method of claim 53 wherein the shunting comprises shunting responsive to an individual one of the electrochemical devices having a defined state of charge.

55. The method of claim 53 further comprising disabling the shunting during the second moment in time using at least one shunt switching device.

56. The method of claim 53 further comprising continuing to apply electrical energy to the electrochemical devices after at least one of the electrochemical devices has reached a substantially charged state.

57. The method of claim 53 wherein the shunting is enabled responsive to the disabling.

58. The method of claim 53 wherein the storing comprises storing the electrical energy using the electrochemical devices individually comprising an electrode active material represented by the general formula:
AₐMPO₄,
wherein:
(i) A is Li, and 0<a≦1; and
(ii) M=MIₙ₋ₚMIIₒ, wherein o=p, 0<o≦0.5, MI is iron (Fe), and MII is selected from the group consisting of Be²⁺, Mg²⁺, Ca²⁺, Sr²⁺, Ba²⁺, and mixtures thereof.

59. The method of claim 53 wherein the storing comprises storing the electrical energy using the electrochemical devices individually comprising an electrode active material represented by the general formula:
AₐMₘ(PO₄)₃,
wherein:
(i) A is Li, and 0<a≦5, and
(ii) M is selected from the group consisting of Ti³⁺, V³⁺, Cr³⁺, Mn³⁺, Fe³⁺, Co³⁺, Ni³⁺, Mo³⁺, Nb³⁺, and mixtures thereof, and 1<m≦3; and
wherein A, M, a and m are selected so as to maintain electroneutrality of the electrode active material.

60. The method of claim 59, wherein M is V³⁺.

61. The method of claim 53 wherein the charging comprises charging using electrical energy having a current larger than a current of the electrical energy shunted using the shunting path.
